(19) United States
(12) Patent Application Publication
(10) Pub. No.: US 2007/0154705 A1
(43) Pub. Date: Jul. 5, 2007

(54) Method and device for producing composite elements and composite element

(76) Inventors: Christoph Doeppner, Eichenzell/Luetter (DE); Rolf A.O. Schneider, Rottenburg (DE)

Correspondence Address: FLYNN THIEL BOUTELL & TANIS, P.C., 2026 RAMBLING ROAD, KALAMAZOO, MI, 49008-1631, US

(21) Appl. No.: 10/558,332

(22) PCT Filed: May 15, 2004
(86) PCT No.: PCT/EP04/05241

§ 371 Date: Oct. 10, 2006

(30) Foreign Application Priority Data
May 28, 2003 (DE) 103 25 402.1
Oct. 6, 2003 (DE) 103 47 163.4

(51) Int. Cl. B32B 17/10

(52) U.S. Cl. 428/334; 156/99

(57) ABSTRACT

The aim of the invention is to produce composite elements comprising two glass panes (20, 21) with at least one insert (22), which is placed therebetween and whose surface is not complete with regard to the outer elements, e.g. its surface is perforated, and with at least one transparent, thermoplastic film layer (23). To this end, the composite element prepared in such a manner is placed inside a room from which air can be evacuated and is placed under compacting pressure. By increasing the temperature to a softening point of the film layer, the insert is joined to both glass panes by pressing, during which gases are forced out of the holes, recesses, etc. in the insert and are filled with the film material. This results in a bubble-free, optionally reinforced composite glass element that has an interesting appearance while also being provided with additional functions.

### FIELD OF APPLICATION AND PRIOR ART

The invention relates to a method and a device for producing composite elements having two plate-like outer elements whereof at least one is a glass pane. Between the outer elements is provided at least one insert not constructed in full surface manner relative to the outer elements and at least one light-transmitting, thermally influenceable layer for joining the outer elements to the insert.

DE 200 06 153 U1 describes a plate-like device used for covering balconies. The device comprises two glass panes between which is positioned a perforated plate. The glass panes and perforated plate are bonded with cast resin to form a composite. The production of composite glasses with cast resin adhesives has long been known. However, the problem arises that the cast resin layer introduced between the panes is not uniformly distributed or that air bubbles are formed which cannot be removed again. Another problem is that coated panes in the cast resin composite can also discolour. Such composite glasses can then no longer be used as top quality design elements.

### PROBLEM AND SOLUTION

The problem of the invention is to provide a method and a device for producing the aforementioned type of composite elements with which the latter can be rapidly and inexpensively produced with a high quality. In particular, the composite elements produced according to the invention must be usable as top quality design elements.

The method according to the invention is characterized in that initially the insert and thermally influenceable layer, particularly one or more thermoplastic films, are applied to a first outer element, particularly to the surface thereof which represents the inner surface in the joined together composite element. Firstly the layer and then the insert or firstly the insert and then the layer can be applied. It is also possible to firstly apply the layer, then the insert and then a further layer. It is alternatively possible to apply several insert layers and several layers.

Following the application of the insert and the layer to the first outer element, the latter is joined together with the second outer element to form a composite element, the second outer element being coated or not coated with the layer. The resulting composite element is introduced into an evacuatable area, which is in particular constructed as a flexible, heat-resistant bag. The evacuatable bag can also be constructed in the manner of an accordion bellows, i.e. with two facing, rigid compression plates, in whose vicinity is also located the opening to be sealed and which are linked by the bellows. It is also possible to separately, e.g. mechanically or hydraulically produce the compression pressure and the volume.

A relative vacuum is applied to the area and at least part thereof is pressed onto the composite element under a compression pressure caused by the relative vacuum and then pressing together occurs. In addition, a treatment temperature is set in such a way that combined with the compression pressure the preferably thermoplastic layer is plasticized and consequently in particular completely embraces the insert, whilst avoiding the formation of gas occlusions.

It is in this way possible to produce composite elements, which are joined by a uniformly constructed, light-transmitting and preferably transparent layer. Particularly in the case of the presently considered composite elements with an insert, it often arises in the conventional production methods that the cast resin incompletely or with a nonuniform coating thickness flows round the inserts, air bubbles are enclosed, etc. Such composite elements can then not be used as top quality design elements or do not comply with the relevant safety regulations applied to composite elements which are to fulfil a securing or safety function, e.g. composite elements which are to be used for fall-preventing glazings. However, this problem does not arise with the method according to the invention. It is surprising that larger air occlusions also caused by the shape of the inserts can be completely sucked out, even from the centre of larger surfaces. As a result of the vacuum prevailing in the area or space, the gas occlusions can be extracted from the composite element in the appropriate manner and gas occlusions in the centre of the composite element can be reliably eliminated. In place of the gas occlusions it is possible for the layer then to follow or lag, so that the points where previously gas occlusions were located are completely filled with the material of the layer.

Gas occlusion removal can be assisted by performing a brushing, rubbing or rolling movement acting in the direction of at least one edge of the composite element and in particular on the outer surfaces thereof and/or by relieving a marginal area of the composite element. To this end it is possible to provide a brushing or rolling device either locatable in the evacuatable area and which acts on the latter when it is constructed as a flexible bag or in which in the case of the aforementioned compression plates is produced by shaping and/or flexibility.

In addition to the compression or pressing pressure produced by the vacuum in the evacuatable area, it is possible to introduce an additional compression pressure independent of the vacuum in the area. This can e.g. take place in that an area constructed as a flexible bag is located in an overpressure chamber, e.g. in an autoclave.

The vacuum-caused pressing pressure or the total pressing pressure can be in the range 5 to 25 bar, particularly 12 to 18 bar.

The treatment temperature should be set in such a way that the light-transmitting, particularly transparent, thermally influenceable layer starts to flow and flows round the insert or inserts. The treatment temperature can be chosen in the range 50 to 200øC, particularly 100 to 150øC. As a function of the thermal characteristics of the layer, it is also possible to set other treatment temperatures.

Preferably the at least one insert is formed by one which is not in full surface form with respect to the outer elements, so that there are regions in the composite element which are covered by the insert, whereas others are not. Insert-free regions can be completely filled with the film material. The film strength and quantity must be selected in such a way that following the filling of the recesses in the insert material is still available in order to ensure a full-surface bonding between the insert and both outer elements. Advantageously for this purpose a film is placed between the insert and each outer element.

The insert can be enclosed in a marginal area and project over the composite element. This offers the advantage of using the insert as a fastening element for the composite panes or the like.

The insert can be a composite-reinforcing, particularly strength-increasing material, which has a higher strength or toughness than the glass pane, so that the composite element can also be used as a fall-preventing glazing, e.g. for guardrails, balcony glazings, etc., in the case of overhead glazings, such as canopies or the like, glass facades, doors, signs, partitions, stairs, etc. For example in the case of overhead glazings it is not permitted to drill in the tension zone glasses which are subject to stresses without fixing the glass there. It is impossible to make a hole, e.g. in order to thus introduce an optical effect. The weakening of the glass is eliminated by a reinforcement through the vacuum process. In the case of a power supply an externally accessible electric load can even be fitted there.

The composite-reinforcing material can be a light-transmitting plastic, preferably acrylic, polycarbonate, etc., metal, preferably in sheet form, e.g. as a perforated plate, metal or plastic knitwear, such as woven or knitted fabric, scrim, carbon fibres, wood or combinations of the aforementioned materials.

The composite-reinforcing material can be simultaneously used as a decorative element. It is possible to integrate very varied decorative elements in the form of an insert in the composite element, e.g. narrow material strips, e.g. of metal, which form a specific shape, light-transmitting plastic, particularly acrylic glass which is artistically designed, e.g. has an engraving, or which has been worked by sand blasting, etc.

In particularly preferred manner the insert is at least one electrical load, preferably a lighting means or illuminant, e.g. a diode, particularly a LED. Alternatively other electrical loads can be used as the insert, e.g. a monitoring device, e.g. in the form of a camera, an acoustic irradiation device, e.g. in the form of a loudspeaker or signal generator for a bell-push and/or a motion or movement detector.

Several lighting means can be used, which are more particularly arranged in a regular grid pattern. It is alternatively possible to form a field with closely positioned lighting means, which as from a specific spacing from the composite element appear as a single light source. Such lighting means can be used for displaying letters, numbers or other symbols. For example, it is possible to form a moving script display through a corresponding arrangement of lighting means. It is possible to integrate into the composite element lighting means of different colours, e.g. in red or green, so that symbols in these signal colours can be formed. For example, in the case of a glass door red and green signal diodes can be integrated e.g. in the area above the door lock indicating whether the door is locked or unlocked. The signal diodes could also be coupled with an identifying device, e.g. a card reader, so that on release the green diode lights up. The electrical connections for the lighting means can also be integrated into the composite element. For example, this can be in the form of a relatively thin wire on which are successively lined up in series-connection the said lighting means. By means of a corresponding wire guidance, e.g. wire bends, it is possible to form other circuits, e.g. combination circuits, parallel circuits, etc. It is alternatively possible to use in place of the wire an electrically conductive layer, which e.g. in the form of thin film strips is positioned on the inner surface of one of the outer elements. It is possible to provide both inner surfaces of glass panes in large area manner with an electrically conductive, optionally transparent layer, so that one inner surface forms the positive pole and the other inner surface the negative pole. It is possible to apply an electrically conductive coating to at least one outer element, e.g. by evaporating or spraying on or by burning in.

The lighting means can be coupled to a light sensor, which switches them on and off as a function of a preset brightness. It is also possible to alternately control several lighting means, e.g. to fade in or out several lighting means arranged in mutually independent circuits in order to produce an optical effect in the manner of a twinkling starry sky.

It is possible to use as an insert at least one heating means, e.g. a heating wire. Thus, e.g. in the case of a composite element used as an overhead glazing heating can be brought about in order to eliminate deposits of snow and ice on the composite element, so that the snow simply slides down in the case of a sloping canopy. A combination of lighting means and heating means is also possible, e.g. in such a way that the power supply of the lighting means simultaneously serves as heating means.

It is also possible to provide as the insert a combination of lighting means and composite-reinforcing and/or decorative material, e.g. a combination of light-transmitting plastic and at least one diode. The lighting means can be positioned at the edge of a light-transmitting plastic element, so that as a result of the light conducting characteristics of the plastic the entire plastic element can be illuminated. Thus, illuminated plastic signs can be integrated into the composite element.

The insert can also be in the form of a light guide. For the emission of light, it can have emitting surfaces in its longitudinal path or at one end which irradiate light at an angle to said longitudinal path. Several emitting surfaces can be provided in the longitudinal path. The emitting surfaces can be cut at an angle into the light guide. The light guide can be constructed in random manner. Advantageously its longitudinal path is bifurcated, so that it can be more easily inserted. This bifurcating into several branches makes it possible for it to have a few or only a single irradiation point for a light source and/or several emission points or surfaces.

The light guide can have a light source located outside the outer elements and is advantageously replaceable, particularly in the form of a LED. Thus, in the case of a defect to a filament lamp or even a LED, e.g. as a result of the operating time or faulty production, easy replacement is possible.

In principle, any possible light guide can be used. The light guide can be in the form of fibres, strands or flat profiles. Possible materials are glass or plastic. This is dependent on the desired use, particularly the shape or configuration of the light guide.

The layer is usually a thermoplastic film. The film can be coloured or uncoloured. Preference is given to the use of a tear-resistant film, e.g. a polyvinyl butyral film (PVB film) usable for producing composite safety glass (CSG). The film can conduct current, so that it can be simultaneously used as a power supply for electrical loads in the composite element.

The outer elements are preferably two glass panes e.g. of float glass, toughened glasses, such as single thickness safety glass (STSG), zone toughened glass (ZTG), optical glasses, such as ornamental glass, polished glass and/or light-transmitting plastic, such as acrylic glass, polycarbonate glass, etc. Thus, it is e.g. possible to have a composite element in the form of two acrylic glass panes with an interposed insert. In the case of polished glass the inner surface of the outer element can be provided with a reflecting coating. In the case of a coating with a metal layer it can simultaneously serve as an electrically conductive layer and therefore as an electrical connection for electrical loads integrated into the composite element. It is alternatively possible for one outer element not to be a glass pane, but instead to be made from a different material, e.g. metal, particularly in the form of a sheet metal plate, stone, rock, etc.

Prior to the vacuum thermal treatment in the evacuatable area, it is possible to carry out a pretreatment in such a way that the two outer elements, the at least one insert and the at least one layer are precompressed or precompacted to a precomposite under a precompression or precompaction pressure and said precomposite is introduced into the evacuatable area. Preferably the precompacting pressure is applied in the horizontal state of the outer elements and can e.g. be applied by rolling onto the top outer element. A pretreatment temperature can be set, so that the layer starts to flow and brings about cohesion between the individual components of the composite element, so that the precomposite can also be positioned edgewise. The resulting precomposite can then be introduced edgewise into the evacuatable area, so that several precomposites can be juxtaposed.

The invention also relates to a composite element, which is characterized in that two, particularly plate-like outer elements are provided, whereof at least one is a glass pane. Between the outer elements is provided at least one insert, more particularly not constructed in full surface manner with respect to the outer elements, and at least one light-transmitting, thermally influenceable layer for joining the at least one outer element to the insert. Preferably the light-transmitting layer is shaped in vacuum thermal manner and is gas occlusion-free. In the case of a non-full surface insert, the insert-free zones within the composite element can be completely filled in gas bubble-free manner with the layer. The composite element can be a mirror, which has a reflecting coating, particularly a metal coating and there is at least one through opening or port for receiving at least one insert, particularly a diode. The through opening can continue as a blind hole in the outer element constructed a glass pane. By means of a filling layer substantially filling the through opening the insert can be fixed in the latter. The reflecting coating can be electrically conductive and therefore serve as a power supply for integrated inserts in the form of electrical load, particularly diodes.

The invention also relates to a device for performing the method for producing composite elements. A heating means, particularly a furnace, is adjustable to a treatment temperature suitable for rendering thermoplastic a light-transmitting, particularly transparent layer required for a composite element to be produced. The heating device is coupled to an evacuatable area for receiving individual components of the composite element to be produced or at least one precompacted precomposite. The evacuatable area is coupled to a vacuum producing device for producing a vacuum in the area, which has at least one vacuum-movable pressing element which can be pressed onto the composite element under a pressing or compacting pressure.

Preferably the evacuatable area is constituted by a flexible, heat-resistant bag, the bag envelope representing the pressing element. The vacuum producing device can e.g. be a vacuum pump.

It is preferable to use an autoclave into which is integrated the heating device and which has an overpressure producing unit for producing an overpressure acting as an additional compacting pressure on the composite element to be compressed.

For further details of the inventive device for producing composite elements reference is made to the above description and the following description of preferred embodiments.

The above and further features can be gathered from the claims, description and drawings and the individual features, both singly or in the form of subcombinations, can be implemented in an embodiment of the invention and in other fields and can represent advantageous, independently protectable constructions. The subdivision of the application into individual sections and the subheadings in no way restricts the general validity of the statements made thereunder.

### BRIEF DESCRIPTION OF THE DRAWINGS

Embodiments of the invention are described hereinafter relative to the attached diagrammatic drawings, wherein show:

FIG. 1 A sectional representation of a first embodiment of an inventive device for the production of composite elements.

FIG. 2 A front view of the device of FIG. 1.

FIG. 3 Methods steps 3a to 3c in the production of the precomposite according to the inventive method.

FIG. 4 Method steps 4a to 4c in the vacuum thermal treatment for the production of a composite element according to the inventive method.

FIG. 5 A representation of a second embodiment of an inventive composite element.

FIG. 6 A perspective view of a third embodiment of the composite element.

FIG. 7 A representation of a fourth embodiment of the composite element.

FIG. 8 A perspective view of a fifth embodiment of the composite element.

FIG. 9 A representation of a sixth embodiment of the composite element.

FIG. 10 An edge view of the composite element of FIG. 9.

FIG. 11 A representation of a seventh embodiment of the composite element.

FIG. 12 A representation of an eighth embodiment of the composite element.

FIG. 13 A perspective, exploded view of a composite element.

### DETAILED DESCRIPTION OF THE EMBODIMENTS

FIG. 1 diagrammatically shows a first embodiment of an inventive device 11 for the production of composite elements 12. Device 11 comprises a conveyor belt 13 with which it is possible to convey in the precompacted precomposites, an autoclave 14 for the thermal overpressure treatment of the composite elements 12 to be produced and an evacuatable area or space in the form of a flexible bag 15 for receiving and for the vacuum thermal treatment of the composite elements 12, the flexible bag 15 and composite elements 12 being introduceable into the autoclave 14.

Standard autoclaves 14 can be used and essentially comprise a pressure-resistant and temperature-resistant chamber to be dimensioned in such a way that several composite elements 12 can be introduced edgewise. The vertical or edgewise placing of the composite elements in the autoclave has, compared with a horizontal placing, the advantage that their weight essentially lacks any influence during the production process. It can arise in the case of horizontal placing that bottom composite elements 12 are more strongly compacted by the weight of the overlying composite elements 12, so that a constant production quality is not ensured. The autoclave 14 has a compressed air pump 16 for producing compressed air and a heating device 17 for heating the compressed air and for setting a treatment temperature. The treatment temperature is in the range 100 to 150øC, e.g. 130øC. Thus, hot air flows in under an overpressure, the overpressure acting as an additional compacting pressure on one or more composite elements 12 in autoclave 14. An air circulation exists, so that the air is constantly circulated in the autoclave 14 and is consequently constantly being recompressed and reheated.

The flexible bag 15 is dimensioned in such a way that it can receive one or more composite elements 12, optionally separated by intermediate elements 25. Following the reception thereof it can be sealed in airtight manner. The flexible bag 15 can e.g. be made from a heat-resistant plastics material. On the bag 15 is provided an air conduit 18 with a check valve, the air conduit 18 being connected to a vacuum pump 19 used for evacuating the bag 15, i.e. for producing a vacuum. Through the evacuation of the bag 15, its envelope clings to the composite element 12 to be produced and presses the latter together with a pressing or compacting pressure. The compacting pressure is between 12 and 18 bar, e.g. 15 bar. The total compacting pressure acting on the composite element 12 to be produced is consequently formed by the compacting pressure arising through the vacuum-caused clinging of the bag, and the additional compacting pressure resulting from the compressed air in the autoclave.

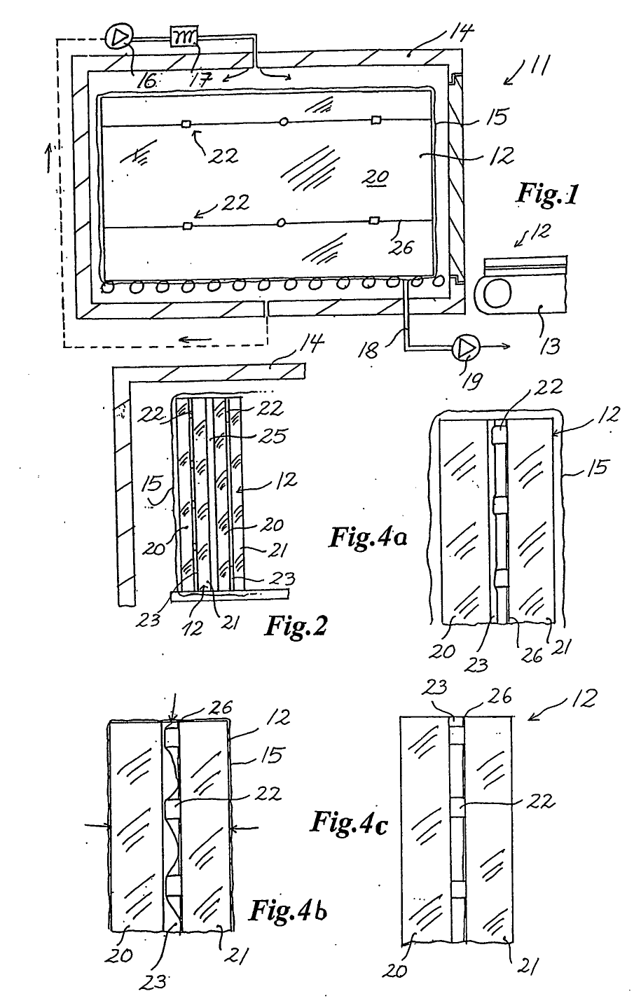

The present composite elements 12 preferably comprise two plate-like outer elements 20, 21, represented here in exemplified manner by glass panes. There is at least one insert 22 between the two glass panes and which are here represented in exemplified manner by diodes (FIGS. 1, 2, 3 and 4) and a composite strength-reinforcing material insert (FIGS. 2, 5 and 6), e.g. of light-transmitting plastic in the form of acrylic glass. Also between the two glass panes is provided a light-transmitting, thermally influenceable layer 23 for linking the outer elements 20, 21 with the insert 22, i.e. the glass panes with diodes, represented here in exemplified manner in the form of a thermoplastic film. Preferably a tear-resistant polyvinyl butyral film is used as the thermoplastic film.

The embodiment of a composite element shown in FIG. 11 constitutes an alternative. The composite element is in the form of a mirror having a reflecting coating. The inserts are once again in exemplified manner shown in the form of diodes, which are fixed on a planar inner surface or in a blind hole 28 of the glass pane.

Method

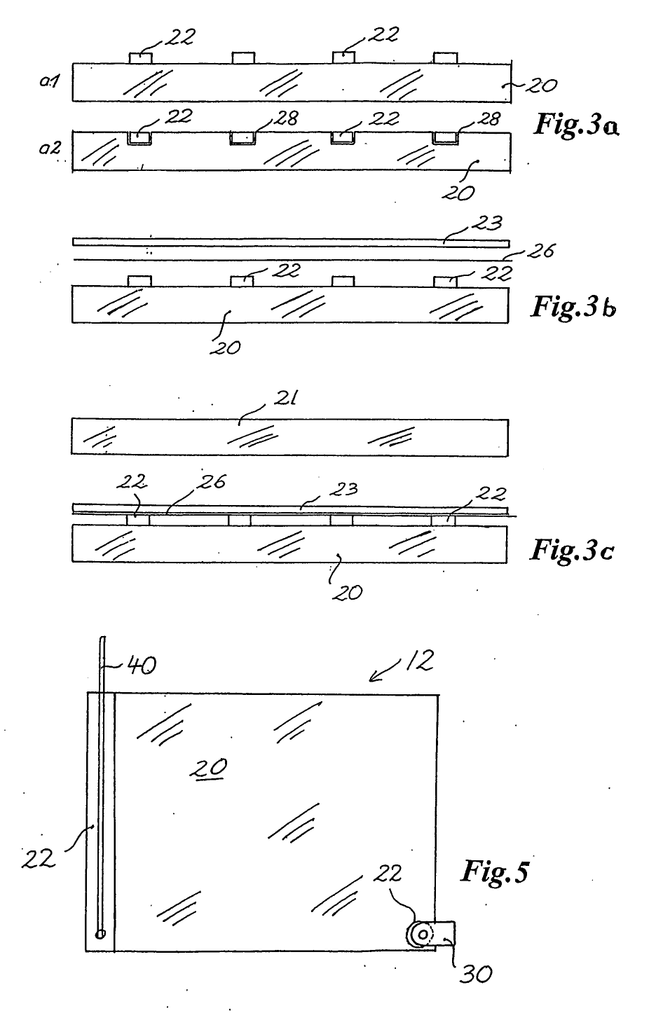

FIG. 3 shows in exemplified manner the production of a precomposite using the successive method steps 3a to 3c. The precomposite is produced in the horizontal state and initially a first outer element 20, e.g. in the form of a glass pane, is placed on a substrate. As shown in FIG. 3a1 it can be a glass pane with a smooth inner surface or, as shown in FIG. 3a2, a glass pane with blind holes 28 on the inner surface thereof. The blind holes 28 are used for substantially completely receiving the inserts 22, which in exemplified manner are shown in the form of diodes.

As shown in FIG. 3a1, the diodes are fixed on the inner surface of the glass pane at predetermined points by means of a fixing medium. In the alternative of FIG. 3a2 the positions of the diodes are already predetermined by the position of the blind holes 28, in which the diodes are fixed by means of a fixing medium. Through the introduction of the fixing medium, e.g. an adhesive, the matt blind holes become more light-transmitting.

As shown in FIG. 3b, next the power supply of the diodes, represented here in exemplified manner by a preferably relatively thin wire, is fixed, preferably soldered to the diodes. The wire piece between the two solder points of a diode is then cut out. Next a light-transmitting, thermally influenceable layer 23 in the form of the thermoplastic film is placed on the diodes.

It is alternatively possible to firstly position the film and then the diodes in the form of a previously soldered diode row is placed thereon.

The last method step in the production of the precomposite, as shown in FIG. 3c, involves the second outer element 21, which is also shown in exemplified manner in the form of a glass pane, is placed on the previously produced sandwich of the glass pane, insert 22 and layer 23 and compressed with a precompacting pressure, which can be applied manually or by a suitable rolling, brushing or rubbing apparatus.

The precomposite is then conveyed by conveyor belt 13 to the autoclave 14 and is placed edgewise, optionally together with other composite elements 12, initially in the flexible bag 15, which can e.g. already be located in the autoclave 14. Following the introduction of the at least one composite element 12, the bag 15 is sealed in airtight manner, e.g. welded airtight.

As shown in FIG. 4, the composite element 12 is located in the airtight welded, flexible bag 15, the bag envelope, as shown in FIG. 4a, still being loosely positioned on the composite element 12. By operating the vacuum pump 19 air is then pumped out of the bag 15, so that there is a vacuum in the latter and, under a compacting pressure, the bag envelope is pressed onto the composite element 12 (FIG. 4b). By closing the check valve said vacuum state can be maintained over the desired treatment period. Substantially simultaneously with the production of the vacuum in the bag, the autoclave 14 is put into operation, so that hot compressed air flows into the autoclave chamber. The overpressure produced by means of the compressed air now acts in addition to the vacuum pressing pressure of the bag 15 on the composite element 12 to be compressed. The hot air brought to the treatment temperature results in the thermoplastic film starting to flow, so that in the manner shown in FIG. 4b, the intermediate spaces between the individual diodes are filled with the layer 23 until, as shown in FIG. 4c, they are completely filled with layer 23. If during the precompacting of the precomposite a precompacting pressure or a pretreatment temperature has already been set which was adequate in order to make the thermoplastic film flow, the gas occlusions, particularly air bubbles arising during precompacting are completely removed through the vacuum thermal treatment in the autoclave 14 and completely filled with the layer.

Instead of producing a vacuum, it is possible to work solely with the overpressure outside the evacuatable area, i.e. with a relative vacuum and then the bag only has to be vented.

As a result of the method according to the invention composite elements are obtained, which are characterized in that there are no air bubbles or other irregularities and which have inserts 22 which are cleanly embedded between the two outer elements 20, 21. Such inventive composite elements 12 can be used as top quality design elements and through being free from gas occlusions also fulfil safety requirements applying to fall-preventing glazings.

FIG. 5 shows a composite element 12 which, in place an insert 22 formed by diodes, has an insert 22 of composite strength-increasing material, which is in exemplified manner shown on the marginal areas of composite element 12 in the form of relatively narrow material strips or, as shown to the right at the bottom of FIG. 5, is inserted as a relatively small insert disk or pane. The composite strength-increasing material can e.g. be light-transmitting plastic in the form of acrylic glass. The composite element 12 shown in FIG. 5 can e.g. be used as a fall-preventing glazing for guardrails, etc., because the inserted composite strength-increasing materials increase the strength of the composite element 12 in such a way that it satisfies the relevant safety requirements for fall-preventing glazings. In the insert panes holes can be made where fixing elements, e.g. glass point holders 30 can be fixed. The advantage is that said holes can be located on portions of the composite element 12 which would be inadmissible for purely glass composite elements without an insert, because there it is necessary to maintain a minimum spacing of approximately 8 cm from the edges.

Another field of use of such composite elements is provided by canopies. As a function of the position of the composite strength-increasing material in the composite element holes can be made there and used for fixing hanging elements of the canopy, e.g. guy ropes 40, etc.

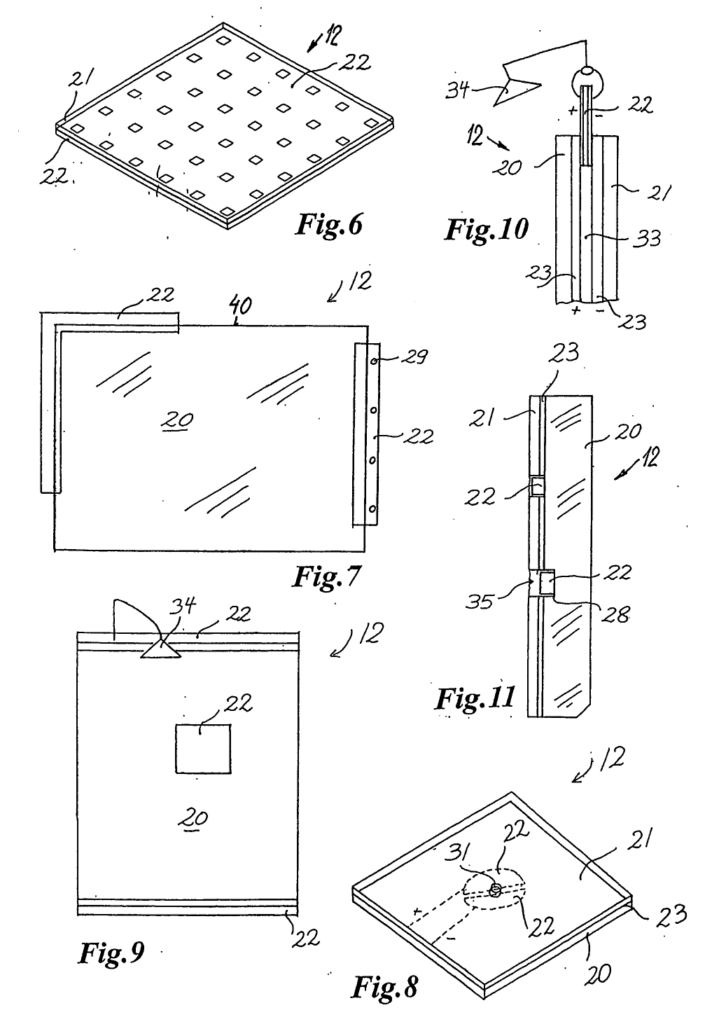

FIG. 6 shows a composite element 12 using a perforated plate as insert 22. Such perforated plate composite elements can be used decoratively and have high safety-relevant features. For example, such perforated plate composite elements can be used in decorative, burglary-inhibiting manner in glass doors.

FIG. 7 shows a composite element 12 using a reinforcing material as insert 22 and which projects out of the composite element 12 and which is optionally positioned crosswise. Use can be made of reinforcing material extending substantially over one side of the composite element 12 or reinforcing material in the form of small parts, such as disks, clips, etc. On the projecting portions of the inserts 12 can be provided holes 29, so as to be able to fix thereto at least one additional element, such as a fastening element, e.g. in the form of a guy rope 40 or the like. It is also possible to fix further, particularly similar composite elements 12 to the composite element portions projecting over the edge 40. This is e.g. of interest for canopies formed from several composite elements 12. Alternatively at least one, preferably relatively small, e.g. circular disk-shaped element (not shown) can be integrated in the vicinity of the centre of the composite element. A glass pane of the composite element can have a recess in order to fix there an additional element to the insert 22. Another possibility is to use the composite element as a stair, can then be fixed to the projecting portions of the staircase.

FIG. 8 shows a composite element 12 usable as an overhead glazing. Use is made of a reinforcing material as insert 22 and is e.g. shown in the form of two half-panes. In the case of overhead glazings it is not permitted to drill toughened glasses in the tension zone without simultaneously fixing said glasses there. However, as a result of the reinforcing insert 22 the composite element 12 is reinforced at least in the vicinity of the insert 22, so that there at least one hole 31 can be provided which is not intended for receiving fixing elements and which e.g. instead serves for receiving electrical loads. The disk or pane-like insert 22 can simultaneously serve as the power supply for the load, e.g. one half-pane can serve as the positive pole and the other half-pane as the negative pole.

FIGS. 9 and 10 show a composite element 12 using as the insert 22 a fastening element projecting from the composite element 12 and which is embedded between two electrically conductive layers. The electrically conductive layers can in each case be a light-transmitting, particularly transparent, thermally influenceable layer 23 in the form of an electrically conductive, thermoplastic film. The two electrically conductive layers 23 can be separated from one another by a non-conducting intermediate layer 33. The fastening element has two electrically conductive outer surfaces, which as a positive and negative pole respectively are coupled to the corresponding, electrically conducting layer 23 and to which is fixed an electrical load, e.g. in the form of a lamp 34. The electrically conducting layers 23 are connected to a power supply also integrated in the form of insert 22 in the composite element. A solar cell can be used as the power supply.

FIG. 11 shows a composite element 12 constructed as a mirror with a reflecting coating 21. For production purposes, on the glass pane constructed as the outer element 20 is initially applied, e.g. evaporated or deposited a reflecting coating. In said reflecting coating are then made through openings 35, e.g. by drilling, sandblasting, etc. The through opening can be extended into the glass pane in the form of a blind hole 28. it is alternatively possible to provide the blind hole prior to the application of the reflecting coating 21. In said through opening 35 is then placed an insert 22 in diode form and is fixed by a filling layer substantially filling the through opening. The diode is supplied via the conducting layer 23 and this can take place through opening 35. In the case of the blind hole, the reflecting coating 21 can be subsequently supplied in through form. Due to the fact that the lighting means, preferably the diode, is located in the blind hole 28, light is also transported within the glass pane and brightens matt, preferably sandblasted surfaces (marginal strips illuminated as facets) or ornaments, which are sunk on the inner or preferably outer surface of the outer element 20.

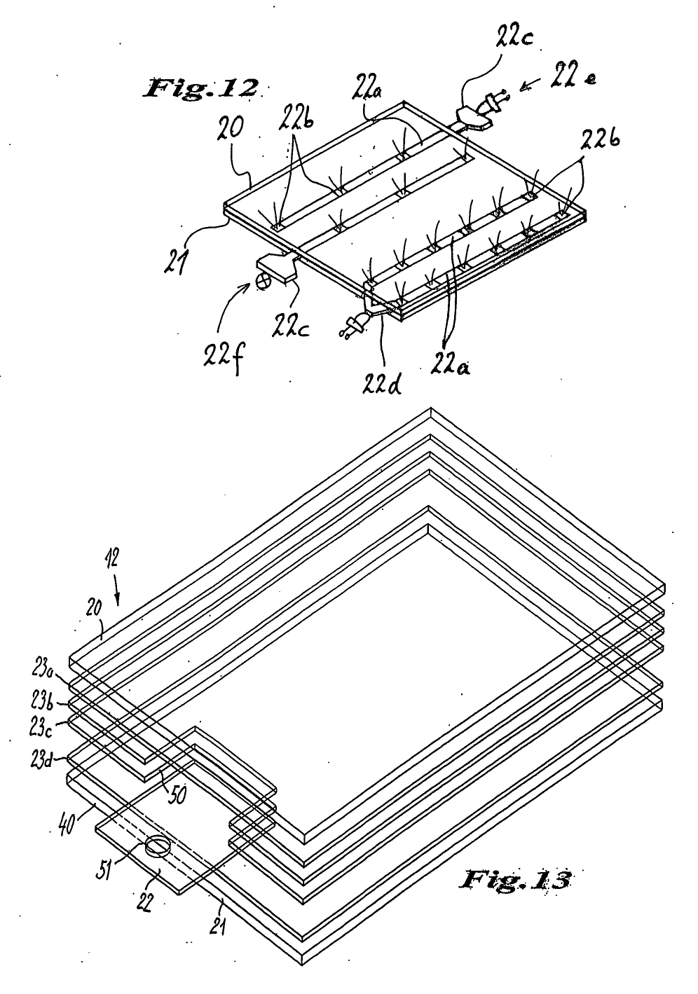

FIG. 12 shows a composite element 12 with an integrated light guide. It is a variant of the embodiment of FIG. 6. Light guides 22a in different forms are introduced between the glass panes 20, 21. To the far left the light guide 22a is straight and projects out of the composite element 12. On the outside a LED 22e is provided at the infeed point 22c, where light from LED 22e is fed in to the light guide 22a. As shown in the drawing, light is fed out at irradiation surfaces 22b. To this end the irradiating surfaces 22b can be constructed as angular grooves or the like in the light guides or also can be formed by material inclusions, etc.

An external filament lamp 22f can be provided in place of an external LED. As an alternative to the external arrangement of the light sources, they can also be integrated between the glass panes 20, 21, but can then hardly be replaced.

To the far right is shown a further light guide construction and is bifurcated behind the infeed point 22c so as to form two parallel branches 22a. They can also have a random configuration, e.g. curved. A single light source is sufficient for a plurality of irradiating surfaces 22b or light points at composite element 12. The irradiating surfaces can emit in alternating or random directions, e.g. also in the longitudinal direction of the composite element.

FIG. 13 is an exploded view of a composite element 12 with an insert 22, e.g. prior to joining. Insert 22 in the form of a plate-like attachment member is fixed between two glass panes 20, 21. For this purpose all four film layers 23a-d in the form of a thermoplastic layer 23 are introduced between the panes. The layers 23a and 23d adjacent to the panes are continuous over the entire pane surface, whereas the middle layers 23b and 23c have cutouts 50, whose size and shape correspond to that part of the insert which engages between the panes.

The thickness of the films is shown in exaggerated form for illustration purposes. The two middle layers 23b, c together should be roughly as thick as the insert and embrace the latter on heating under pressure. The insert could also have not shown recesses into which the film material flows during the melting joining operation. The layers 23a, d produce the flat, adhesive connection between insert 22 and panes 20, 21. The insert e.g. provided with a fastening hole 51 can be fitted a number of times to the composite element edge 40 and permits a reliable, breakthrough-free installation of the element.

Tests have shown that this type of retaining glass components is far superior to all other positive or non-positive installation types. It also helps to make the metal/glass joint have a large surface area, prevents direct metal/glass contact, ensures that the plastic film acts in shock-absorbing and force-compensating manner and as a result of the very thin film layer produces an excellent joint between insert and glass.

1. Method for producing composite elements (12), with two plate-like outer elements (20, 21), whereof at least one is a glass pane, at least one insert (22) located substantially between the outer elements (20, 21) and at least one more particularly transparent, thermally influenceable layer (23) for linking the outer elements (20, 21) with the insert (22), said method having the following steps:
introducing insert (22) and layer (23) between outer elements (20, 21),
introducing composite element (12) into an evacuatable area, particularly into a flexible bag (15),
applying a relative vacuum to the area, at least part of said area being under a compacting pressure caused by said relative vacuum is pressed onto the composite element (12) and the latter is compressed and
setting a treatment temperature in such a way that, combined with the compacting pressure, the layer (23) flows round the insert (22), whilst avoiding gas occlusion formation.

2. Method according to claim 1, characterized in that in each case a thermoplastic film layer (23) is inserted between insert (22) and outer elements (20, 21).

3. Method according to claim 1, characterized in that the insert (22) is not constructed in full surface manner relative to the outer elements (20, 21) and insert-free zones of the composite element (12) are completely filled with the material of the layer (23), the gas occlusions in the composite element (12) being removed.

4. Method according to claim 1, characterized in that a brushing or rolling movement acting in the direction of at least one edge of the composite element (12) assists the removal of gas occlusions and/or at least one marginal area of the composite element (12) is relieved in order to facilitate an escape of the gas occlusions.

5. Method according to claim 1, characterized in that the composite element (2) is compressed on all sides, but least in the vicinity of its two outer surfaces, particularly by means of an area constructed as a flexible bag (15), which completely embraces at least one composite element (12).

6. Method according to claim 1, characterized in that for the compacting of the composite element (12) an optionally additional compacting pressure which is independent of the vacuum in the area is applied and is produced by means of an overpressure producing device, particularly using an autoclave.

7. Method according to claim 1, characterized in that a compacting pressure of 5 to 25 bar, particularly 12 to 18 bar is chosen and/or a treatment temperature of 50 to 200° C., particularly 100 to 150° C. is chosen.

8. Method according to claim 1, characterized in that the insert (12) is made from composite-reinforcing material, at least one decorative element and/or at least one electrical load, such as lighting means, heating means, etc., preferably a material which is more fracture-resistant than glass, e.g. light-transmitting plastic, preferably acrylic, polycarbonate, etc., metal, preferably in sheet form, e.g. as a perforated plate, metal or plastic knitwear, such as woven or knitted fabric, scrim, carbon fibres and/or wood or combinations of the aforementioned materials.

9. Method according to claim 8, characterized in that the lighting means are diodes, particularly LEDs.

10. Method according to claim 1, characterized in that the insert (22) is a light guide (22a), which in particular has emitting surfaces (22b) in the longitudinal path or at one end emitting light at an angle to its longitudinal path and it preferably has a light source (22e, 22f) located outside the outer elements (20, 21).

11. Method according to claim 1, characterized in that the layer (23) is in particular a thermoplastic film, which is preferably colourless and/or tear-resistant.

12. Method according to claim 1, characterized in that a pretreatment is performed in such a way that the two outer elements (20, 21), the at least one insert (22) and the at least one layer (23) are precompacted to a precomposite under a precompacting pressure and is brought into the evacuatable area and preferably in the horizontal state the outer elements (20, 21) are precompacted and the resulting precomposite is introduced edgewise into the area.

13. Method according to claim 1, characterized in that for joining the outer elements (20, 21) several layers (23) are inserted, whereof at least one is cut out in accordance with the design of the insert (22), but preferably in each case one layer (23) runs between the insert and outer elements.

14. Composite element with two plate-like outer elements (20, 21), whereof at least one is a glass pane, at least one is an insert (22) substantially located between the outer elements (20, 21) and at least one is in particular a transparent, thermally influenceable, film-like layer (23), which connects the outer elements (20, 21) to one another and to the insert (22).

15. Composite element according to claim 14, characterized in that between the insert (22) and the outer elements is in each case provided a film layer (23), which is joined thermoplastically both to the insert and to the outer elements.

16. Composite element according to claim 14, characterized in that the layer (23) is deformed in vacuum thermal manner and is gas occlusion-free, particularly air bubble-free.

17. Composite element according to claim 14, characterized in that the insert (22) is not constructed in full surface manner relative to the outer elements (20, 21) and insert-free zones within the composite element (12) are completely filled with the layer (23).

18. Composite element according to claim 14, characterized in that it is a mirror with a reflecting coating, particularly a metal coating, which has at least one through opening (35) for receiving at least one insert (22) and in particular the through opening is continued as a blind hole (28) in the outer element (20) constructed as a glass pane and the insert, such as a LED, is fixed therein by means of a filling layer substantially filling the through opening.

19. Composite element according to claim 14, characterized in that the insert is a light guide (22a), which in particular has emitting surfaces (22b) in the longitudinal path or at one end which emit light at an angle to its longitudinal path and preferably there are several emitting surfaces in the longitudinal path and/or the light guide (22a) is bifurcated in the longitudinal path preferably so as to give several branches and in particular the light guide has a single irradiation point (22c) for a light source (22e, 22f) and/or several emitting points or emitting surfaces (22b) and the light guide (22a) has a light source located outside the outer elements (20, 21), the light source preferably being replaceable and in particular in the form of a LED (22e).

20. Composite element according to claim 14, characterized in that the insert projects over at least one outer edge (40) of the outer elements (20, 21) and preferably only takes up one marginal area of the outer elements and is in particular a fastening element for the composite element (12).

21. Composite element producible according to a method of claim 1.

22. Device for performing the method according to claim 1, with a heating device (17), particularly a furnace, for setting a treatment temperature suitable for thermally influencing a light-transmitting, particularly transparent layer (23) required for a composite element (12) to be produced and an evacuatable area (15) coupled to the heating device (17) for receiving individual components of the composite element (12) to be produced or at least one precompacted composite element and a vacuum producing device (19), coupled to the area (15), for producing a relative vacuum in said area, which has at least one pressing element pressable onto the composite element (12) under a compacting pressure caused by the relative vacuum.

23. Device according to claim 22, characterized in that the evacuatable area is constituted by a flexible, particularly heat-resistant bag (15).

24. Device according to claim 22, characterized in that a vacuum pump (19) is provided as the vacuum producing device.

25. Device according to claim 22, characterized in that there is an autoclave (14) in which the heating device (17) is integrated and which has an overpressure producing unit (16) for producing an overpressure acting as an additional compacting pressure on a composite element (12) to be produced.
